(19) United States
(12) Patent Application Publication
(10) Pub. No.: US 2026/0237578 A1
(43) Pub. Date: Aug. 13, 2026

(54) ROTARY ELECTRONIC COMPONENT

(71) Applicant: TOKYO COSMOS ELECTRIC CO., LTD., Kanagawa (JP)

(72) Inventor: Hajime FUKUSHIMA, Kanagawa (JP)

(73) Assignee: TOKYO COSMOS ELECTRIC CO., LTD., Kanagawa (JP)

(21) Appl. No.: 19/532,647

(22) Filed: Feb. 6, 2026

(30) Foreign Application Priority Data
Feb. 10, 2025 (JP) 2025-020020

(51) Int. Cl. H01H 25/00; G06F 3/01

(52) U.S. Cl. CPC H01H 25/002; G06F 3/016; H01H 25/006

(57) ABSTRACT

A rotary electronic component capable of suppressing transmission of a click vibration to a rotary body is provided. The rotary electronic component includes: a main body; an operation shaft supported by the main body to be rotatable about an axis extending in one direction; a click mechanism supported by the operation shaft and capable of generating a click vibration in response to rotation of the operation shaft; and a rotary body disposed on the operation shaft at a position away from the click mechanism in the one direction, the rotary body being supported to be integrally rotatable with the operation shaft, the rotary body being capable of generating an electric signal in response to the rotation of the operation shaft.

### CROSS REFERENCE TO RELATED APPLICATIONS

This application is entitled to (or claims) the benefit of Japanese Patent Application No.2025-020020 filed on February 10, 2025, the disclosure of which including the specification, drawings and abstract is incorporated herein by reference in its entirety.

### TECHNICAL FIELD

The present invention relates to a rotary electronic component.

### BACKGROUND ART

For example, Patent Literature (hereinafter, referred to as “PTL”) 1 discloses a rotary electronic component in which, when an inner shaft is rotated, a slider provided in a slider receiver of a variable resistor slides on a resistor provided on a resistance substrate, and a resistance value is adjusted.

### CITATION LIST

### Patent Literature

PTL 1 Japanese Utility Model Publication No. H6-21208

### SUMMARY OF INVENTION

### Technical Problem

PTL 1 described above describes that an elastic arm of a spacer is interposed between a flat portion of an oval-shaped inner shaft and a flat portion of a shaft insertion hole of the slider receiver, and an inner surface of the elastic arm is in pressure contact with the flat portion of the inner shaft. Accordingly, the occurrence of a play in a rotation direction between the inner shaft and the slider is prevented, and thus a timing deviation between the inner shaft and the slider receiver does not occur when the inner shaft is rotated.

A rotary electronic component that transmits a click vibration to an operation shaft in response to rotation of the operation shaft and that can transmit a click sensation to an operator is known.

In such a rotary electronic component, when the click vibration is transmitted to the operation shaft, there is a problem that an electric component disposed on the operation shaft may have difficulty in outputting a stable electric signal.

In addition, in the rotary electronic component, as described in PTL 1, it is necessary to prevent the occurrence of a pay in a rotation direction between the shaft and the rotary body to prevent a timing deviation between the shaft and the rotary body.

Objectives of the present invention include providing a rotary electronic component capable of suppressing transmission of a click vibration to a rotary body.

### Solution to Problem

To achieve the above objectives, a rotary electronic component according to the present invention includes:

a main body;

an operation shaft supported by the main body to be rotatable about an axis extending in one direction;

a click mechanism supported by the operation shaft and capable of generating a click vibration in response to rotation of the operation shaft; and

a rotary body disposed on the operation shaft at a position away from the click mechanism in the one direction, the rotary body being supported to be integrally rotatable with the operation shaft, the rotary body being capable of generating an electric signal in response to the rotation of the operation shaft.

### Advantageous Effects of Invention

According to the present invention, transmission of a click vibration to a rotary body can be suppressed.

### BRIEF DESCRIPTION OF DRAWINGS

FIG. 1 is a diagram showing a rotary electronic component according to an embodiment of the present invention;

FIG. 2 is a cross-sectional view taken along line II-II of FIG. 1;

FIG. 3 is a cross-sectional view taken along line III-III of FIG. 1;

FIG. 4 is a diagram showing a rotary electronic component according to a variation of the present embodiment;

FIG. 5 is a cross-sectional view taken along line V-V of FIG. 4; and

FIG. 6 is a cross-sectional view taken along line VI-VI of FIG. 4.

### DESCRIPTION OF EMBODIMENTS

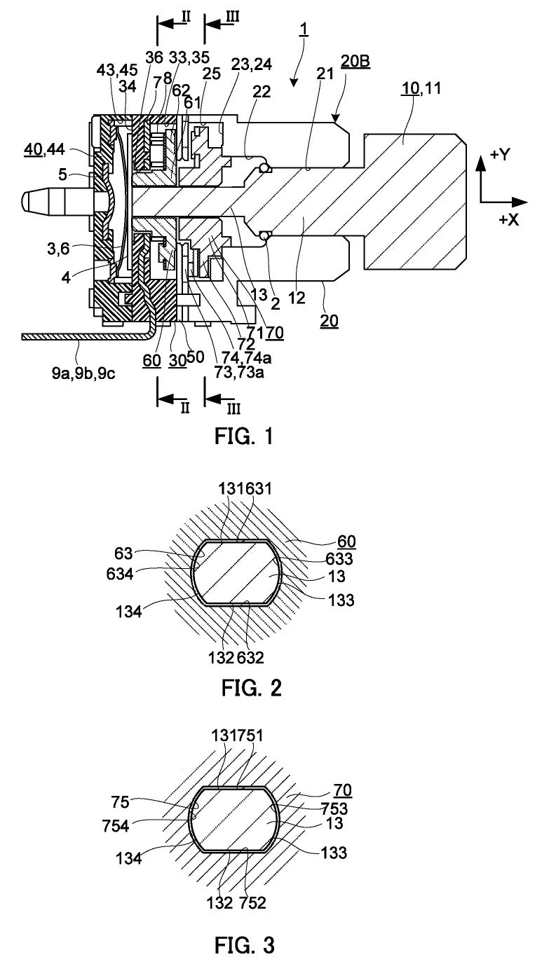

Hereinafter, an embodiment of the present invention will be described with reference to the drawings. FIG. 1 is a diagram showing a rotary electronic component according to an embodiment of the present invention. FIG. 2 is a cross-sectional view taken along line II-II of FIG. 1. FIG. 3 is a cross-sectional view taken along line III-III of FIG. 1. The X-axis and Y-axis are shown in FIG. 1. In FIG. 1, a left-right direction is referred to as an X direction or an axial direction, a right direction is referred to as one side in the axial direction or a "+ direction,” and a left direction is referred to as the other side in the axial direction or a "−X direction.” In addition, an up-down direction is referred to as a Y direction or a radial direction, a direction away from the X-axis is referred to as an outer side in the radial direction or a "+Y direction,” and a direction toward the X-axis is referred to as an inner side in the radial direction or a "−Y direction.” In the following description, the X-axis may be referred to as an "axis,” the phrase “about the X-axis” may be referred to " about the axis,” a direction about the X-axis may be referred to as a "direction about the axis,” rotation about the X-axis may be referred to as "rotation,” a rotation angle about the X-axis may be referred to as a "rotation angle,” a rotation direction about the X-axis may be referred to as a "rotation direction,” a rotational force about the X-axis may be referred to as a "rotational force,” a rotational operation about the X-axis may be referred to as a "rotational operation,” a force in the X-axis direction may be referred to as an "axial force,” and an operation in the X-axis direction may be referred to as an "axial operation.” Rotary electronic component 1 according to the present embodiment is, for example, an electronic component with a click function that converts a rotation angle (position) during a rotational operation into a voltage (electric signal) and that can provide a click sensation to an operator during the rotational operation. Rotary electronic component 1 includes operation shaft 10, first block 20, second block 30, third block 40, rotary body 60, and click mechanism 70.

### Operation Shaft 10

Operation shaft 10 is disposed to extend in the axial direction (X direction). Operation shaft 10 includes large-diameter portion 11, medium-diameter portion 12, and small-diameter portion 13. Large-diameter portion 11 includes a dial and is disposed at an end portion on the one side in the axial direction (+X direction). Medium-diameter portion 12 has a diameter smaller than a diameter of large-diameter portion 11 and is disposed on the other side in the axial direction (−X direction) with respect to large-diameter portion 11. Detachment prevention ring 2 is fitted to an end of medium-diameter portion 12 on the other side in the axial direction. Small-diameter portion 13 has a diameter smaller than the diameter of medium-diameter portion 12 and is disposed on the other side in the axial direction with respect to medium-diameter portion 12.

### Positional Relationship between Three Blocks 20, 30, and 40

First block 20 is disposed at a position on the one side in the axial direction (+X direction) with respect to second block 30. Second block 30 is disposed at a position on the one side in the axial direction with respect to third block 40. That is, first block 20, second block 30, and third block 40 are disposed in order from the one side in the axial direction toward the other side in the axial direction (−X direction). Partition plate 50 is disposed between first block 20 and second block 30. In the following description, first block 20, second block 30, and third block 40 may be collectively referred to as "block 20B.” Block 20B corresponds to a "main body" of the present disclosure.

### Positional relationship between three blocks 20, 30, and 40 and each part of operation shaft 10

First block 20 is disposed at a position on the other side in the axial direction (−X direction) with respect to large-diameter portion 11 (dial). In other words, large-diameter portion 11 is disposed outside first block 20.

Medium-diameter portion 12 is disposed inside first block 20. In other words, medium-diameter portion 12 is disposed between a position of an end of first block 20 on the one side in the axial direction (+X direction) and a position of a central portion in the axial direction.

Small-diameter portion 13 is disposed inside each of first block 20 and second block 30. In other words, small-diameter portion 13 is disposed between the position of the central portion in the axial direction of first block 20 and a position of an end of second block 30 on the other side in the axial direction (−X direction). It should be noted that an end of small-diameter portion 13 (operation shaft 10) on the other side in the axial direction is positioned at a position of an end of third block 40 on the one side in the axial direction (+X direction). Plate 4 is fixed to an end of small-diameter portion 13 on the other side in the axial direction (−X direction).

### First Block 20

First block 20 includes first medium-diameter hole 21, first large-diameter hole 22, and first accommodation portion 23. First medium-diameter hole 21 is disposed at an end portion of first block 20 on the one side in the axial direction (+X direction). Medium-diameter portion 12 penetrates first medium-diameter hole 21. Medium-diameter portion 12 is supported to be rotatable about the axis by first medium-diameter hole 21.

Detachment prevention ring 2 is in rollable contact with a hole circumferential edge at the end of first medium-diameter hole 21 on the other side in the axial direction (−X direction). In a case where detachment prevention ring 2 is in contact with the hole circumferential edge of first medium-diameter hole 21, operation shaft 10 is prevented from falling off to the one side in the axial direction (+X direction) even when operation shaft 10 is biased to the one side in the axial direction by a restoring force of plate spring 3.

First large-diameter hole 22 is concentric with first medium-diameter hole 21, has a diameter larger than first medium-diameter hole 21, and is disposed at a position on the other side in the axial direction (−X direction) with respect to first medium-diameter hole 21.

First accommodation portion 23 includes first seat portion 24 and first tubular portion 25, and is disposed at a position on the other side in the axial direction (−X direction) with respect to first large-diameter hole 22. First seat portion 24 extends from the end of first large-diameter hole 22 on the other side in the axial direction to a radially outer side (+Y direction) to be enlarged in diameter. First tubular portion 25 extends in a tubular shape from a position of an end of first seat portion 24 on the radial outer side to the other side in the axial direction. A portion of small-diameter portion 13 from an end portion on the one side in the axial direction (+X direction) to a central portion in the axial direction is disposed inside first tubular portion 25.

Click mechanism 70 is accommodated in first accommodation portion 23. Details of click mechanism 70 will be described later.

### Second Block 30

Second block 30 includes second accommodation portion 33. Second accommodation portion 33 includes second seat portion 34 and second tubular portion 35. Second tubular portion 35 extends in a tubular shape from the position of the end of first tubular portion 25 on the other side in the axial direction (−X direction) to the other side in the axial direction. Second seat portion 34 extends from an end of second tubular portion 35 on the other side in the axial direction to a radially inner side (−Y direction) to be reduced in diameter. Second seat portion 34 includes second hole 36. Small-diameter portion 13 penetrates second hole 36 in the axial direction (X direction).

Rotary body 60 as an electronic signal control section is disposed in second accommodation portion 33. Details of rotary body 60 (electric component) will be described later.

### Third Block 40

Third block 40 includes third accommodation portion 43. Third accommodation portion 43 includes third tubular portion 45 that extends in a tubular shape from a position of a surface of second seat portion 34 on the other side in the axial direction (−X direction) to the other side in the axial direction. Third accommodation portion 43 includes third seat portion 44 that extends from an end of third tubular portion 45 on the other side in the axial direction to a radially inner side (−Y direction) to be reduced in diameter.

Resistor 7 is disposed on a surface of second seat portion 34 on the one side in the axial direction (+X direction). Both end portions 9a and 9b of resistor 7 pass through the inside of second seat portion 34 and are further extended to the outside of second seat portion 34.

Contacts 5 and 6 are disposed in third accommodation portion 43. Contact 5 is fixed to third seat portion 44. Contact 6 is formed by long plate spring 3 having a restoring force. Both end portions of plate spring 3 in the longitudinal direction are fixed to third seat portion 44. A central portion of plate spring 3 in the longitudinal direction is formed to be curved to the one side in the axial direction (+X direction). In a case where the operator pushes large-diameter portion 11 (dial) to the other side in the axial direction (−X direction), plate 4 moves to the other side in the axial direction against the restoring force of plate spring 3, plate spring 3 is pushed by plate 4 and is deformed to the other side in the axial direction, and contact 6 approaches contact 5, so that contacts 5 and 6 are electrically connected to each other (on state). On the contrary, when the operator does not push large-diameter portion 11 to the other side in the axial direction, plate 4 retreats to the one side in the axial direction (+X direction) by the restoring force of plate spring 3, and contact 6 is separated from contact 5, so that contacts 5 and 6 are not electrically connected to each other (off state).

### Rotary Body 60

Rotary body 60 is accommodated in second accommodation portion 33. Rotary body 60 includes tubular portion 61 and flange portion 62. Tubular portion 61 includes through-hole 63.

Small-diameter portion 13 penetrates through-hole 63 in the axial direction (X direction). A resin having elasticity and insulating properties is used as a material of rotary body 60.

### Small-Diameter Portion 13, Through-Hole 63

Next, the shape of small-diameter portion 13, the shape of through-hole 63, and the like will be described with reference to FIG. 2. FIG. 2 is a cross-sectional view taken along line II-II of FIG. 1. In FIG. 2, illustration of other portions excluding a portion around small-diameter portion 13 and through-hole 63 is omitted.

A wall surface of small-diameter portion 13 has a racetrack-shaped cross-sectional shape. A center of the racetrack-shaped cross-sectional shape matches an axial center of small-diameter portion 13. In the following description, a linear portion of the racetrack shape is referred to as a straight portion.

Small-diameter portion 13 includes first straight portion 131, second straight portion 132, first circumference portion 133, and second circumference portion 134. In FIG. 2, first straight portion 131, first circumference portion 133, second straight portion 132, and second circumference portion 134 are disposed in a clockwise direction. First straight portion 131 and second straight portion 132 are disposed to face each other with the axial center of small-diameter portion 13 interposed therebetween. Each of first straight portion 131 and second straight portion 132 is a flat surface that extends in a direction parallel to the axial direction (X direction) and a direction parallel to the radial direction (Y direction). First circumference portion 133 and second circumference portion 134 have a circumference of the same diameter and are disposed to face each other with the axial center of small-diameter portion 13 interposed therebetween.

Through-hole 63 is a hole provided with a predetermined clearance with respect to small-diameter portion 13. The clearance is set such that the rotational force is transmitted from small-diameter portion 13 to rotary body 60 and the axial force is not transmitted from small-diameter portion 13 to rotary body 60.

A wall surface of through-hole 63 has a racetrack-shaped cross-sectional shape. A center of the racetrack-shaped cross-sectional shape matches the axial center of small-diameter portion 13. In the following description, the linear portion (straight portion) of the racetrack shape is referred to as a "hole flat wall surface.” Through-hole 63 includes first hole flat wall surface 631, second hole flat wall surface 632, first hole circumferential wall surface 633, and second hole circumferential wall surface 634. First hole flat wall surface 631 is disposed to face first straight portion 131 with a clearance therebetween. Second hole flat wall surface 632 is disposed to face second straight portion 132 with a clearance therebetween. First hole circumferential wall surface 633 is disposed to face first circumference portion 133 with a clearance therebetween. Second hole circumferential wall surface 634 is disposed to face second circumference portion 134 with a clearance therebetween. The size of the clearance at each part may be the same or different from each other.

Flange portion 62 is a flange that extends from an end portion of tubular portion 61 on the one side in the axial direction (+X direction) to be enlarged in diameter toward the radial outer side (+Y direction). Movable contact 8 is disposed on a surface of flange portion 62 on the other side in the axial direction (−X direction). Movable contact 8 is slidable while being in contact with resistor 7. Accordingly, when operation shaft 10 is rotationally operated, movable contact 8 slides on resistor 7, and a rotation angle (sliding position) of movable contact 8 can be detected at a voltage ratio between a constant voltage between both terminals 9a and 9b of resistor 7 and a voltage of terminal 9c connected to movable contact 8. That is, rotary body 60 according to the present embodiment is an electric component that generates an electric signal.

### Click Mechanism 70

Click mechanism 70 is accommodated in first accommodation portion 23. Click mechanism 70 includes tubular body 71, flange body 72, perforated board 73, and vibration spring 74. Tubular body 71 includes insertion hole 75. Small-diameter portion 13 is inserted into insertion hole 75 in the axial direction (X direction). A surface of flange body 72 on the one side in the axial direction is in contact with first seat portion 24. In addition, a part of the surface of flange body 72 on the one side in the axial direction is fitted to first large-diameter hole 22.

### Small-Diameter Portion 13, Insertion Hole 75

Next, the shape of small-diameter portion 13, the shape of insertion hole 75, and the like will be described with reference to FIG. 3. FIG. 3 is a cross-sectional view taken along line III-III of FIG. 1. In FIG. 3, illustration of other portions excluding a portion around small-diameter portion 13 and insertion hole 63 is omitted.

As described above, small-diameter portion 13 includes first straight portion 131, second straight portion 132, first circumference portion 133, and second circumference portion 134. In FIG. 2, first straight portion 131, first circumference portion 133, second straight portion 132, and second circumference portion 134 are disposed in a clockwise direction. First straight portion 131 and second straight portion 132 are disposed to face each other with the axial center of small-diameter portion 13 interposed therebetween. Each of first straight portion 131 and second straight portion 132 is a flat surface that extends in a direction parallel to the axial direction (X direction) and a direction parallel to the radial direction (Y direction). First circumference portion 133 and second circumference portion 134 have a circumference of the same diameter and are disposed to face each other with the axial center of small-diameter portion 13 interposed therebetween.

Insertion hole 75 is a hole provided with a predetermined clearance with respect to small-diameter portion 13. The clearance is set such that the rotational force is transmitted from small-diameter portion 13 to click mechanism 70 and the axial force is not transmitted from small-diameter portion 13 to click mechanism 70. The size of the clearance provided between insertion hole 75 and small-diameter portion 13 may be the same as or different from the size of the clearance provided between small-diameter portion 13 and through-hole 63.

Insertion hole 75 includes first hole flat wall surface 751, second hole flat wall surface 752, first hole circumferential wall surface 753, and second hole circumferential wall surface 754. First hole flat wall surface 751 is disposed to face first straight portion 131 with a clearance therebetween. Second hole flat wall surface 752 is disposed to face second straight portion 132 with a clearance therebetween. First hole circumferential wall surface 753 is disposed to face first circumference portion 133 with a clearance therebetween. Second hole circumferential wall surface 754 is disposed to face second circumference portion 134 with a clearance therebetween. The size of the clearance at each part may be the same or different from each other.

Flange body 72 is a flange that extends from an end portion of tubular body 71 on the one side in the axial direction (+X direction) to be enlarged in diameter toward the radial outer side (+Y direction).

Perforated board 73 together with partition plate 50 is screwed to a surface of first block 20 on the one side in the axial direction. Perforated board 73 is a board in which a plurality of recessed portions 73a are disposed at predetermined intervals in the circumferential direction of the shaft.

Vibration spring 74 has a restoring force and is disposed on a surface of flange body 72 on the other side in the axial direction (−X direction). Vibration spring 74 has a fixed end fixed to flange body 72 and a free end that is not fixed to flange body 72 and is positioned at a predetermined distance from the surface of flange body 72 on the other side in the axial direction. The free end has protruding portion 74a that protrudes to the other side in the axial direction (−X direction). Protruding portion 74a is moved to an original position that is a position on the other side in the axial direction (−X direction) by the restoring force and is fitted to recessed portion 73a at the original position. Accordingly, operation shaft 10 is temporarily held at the position. Protruding portion 74a is moved to a deflection position that is a position on the one side in the axial direction (+X direction) against the restoring force and is detached from recessed portion 73a at the deflection position. Accordingly, operation shaft 10 is rotatable from the position.

In response to the rotation of operation shaft 10, the operation of fitting protruding portion 74a into recessed portion 73a and the operation of detaching protruding portion 74a from recessed portion 73a are alternately repeated. Accordingly, vibration spring 74 generates a click vibration. The click vibration is transmitted to small-diameter portion 13, flange body 72 and tubular body 71, and is further transmitted from medium-diameter portion 12 to large-diameter portion 11 (dial). Accordingly, the operator can obtain a click sensation.

Meanwhile, when rotary body 60 and click mechanism 70 are integrally formed, the click vibration might be transmitted to rotary body 60. Since rotary body 60 is an electric component that generates an electric signal, when the click vibration is transmitted to rotary body 60, there is a problem that rotary body 60 may have difficulty in outputting a stable electric signal.

Therefore, rotary body 60 in rotary electronic component 1 according to the present invention is disposed at a position away from click mechanism 70 (tubular body 71, flange body 72) in the axial direction (X direction). Accordingly, since the click vibration is not directly transmitted, the click vibration transmitted from click mechanism 70 to rotary body 60 is reduced. As a result, rotary body 60 can output a stable electric signal.

Rotary electronic component 1 according to the embodiment of the present invention includes block 20B, operation shaft 10 that is supported by block 20B to be rotatable about the shaft extending in the axial direction, click mechanism 70 that is supported by operation shaft 10 and that can generate a click vibration in response to the rotation of operation shaft 10, and rotary body 60 that is disposed at a position away from the click mechanism in the axial direction of operation shaft 10, that is supported to be integrally rotatable with operation shaft 10, and that can generate an electric signal in response to the rotation of operation shaft 10.

According to the above configuration, since rotary body 60 and click mechanism 70 are disposed to be spaced from each other in the axial direction, it is possible to suppress the transmission of the click vibration from click mechanism 70 to rotary body 60.

Meanwhile, the click vibration transmitted from click mechanism 70 (tubular body 71, flange body 72) to small-diameter portion 13 may be transmitted to rotary body 60 via small-diameter portion 13. Since rotary body 60 is an electric component that generates an electric signal, when the click vibration is transmitted to small-diameter portion 13, rotary body 60 (electric component) disposed on small-diameter portion 13 has difficulty in outputting a stable electric signal. Therefore, it is preferable to suppress the click vibration transmitted to rotary body 60 via small-diameter portion 13.

### Variation

Next, a variation of rotary electronic component 1 according to the embodiment of the present invention will be described. In the description of the variation, a configuration different from the embodiment will be mainly described, and the description of the same configuration will be omitted.

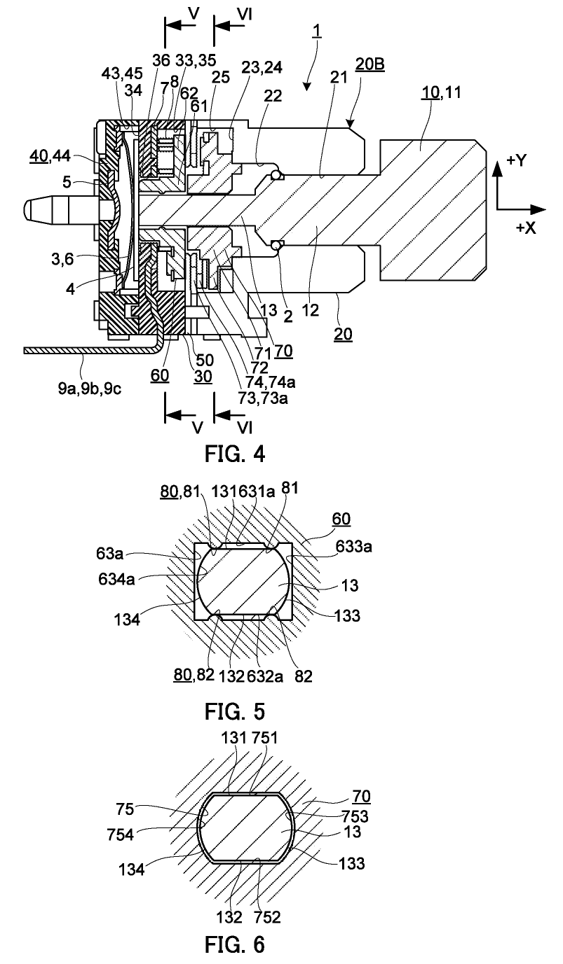

FIG. 4 is a diagram showing a rotary electronic component according to Variation 1 of the present embodiment. FIG. 5 is a cross-sectional view taken along line V-V of FIG. 4. FIG. 6 is a cross-sectional view taken along line VI-VI of FIG. 4.

As shown in FIG. 4, transmission suppression section 80 that can suppress the click vibration transmitted from click mechanism 70 to rotary body 60 via operation shaft 10 is disposed in rotary body 60 according to Variation 1.

As shown in FIGS. 5 and 6, the shape of small-diameter portion 13 according to Variation 1 is the same as the shape of small-diameter portion 13 according to the embodiment. The present invention is not limited thereto, and the shape of small-diameter portion 13 may be different from the shape of small-diameter portion 13 according to the embodiment.

As shown in FIG. 5, a wall surface of through-hole 63a according to Variation 1 is different from the wall surface of through-hole 63 according to the embodiment. The wall surface of through-hole 63a has a substantially rectangular cross-sectional shape. The substantially rectangular cross-sectional shape and small-diameter portion 13 have the same axial center. Through-hole 63a includes first hole flat wall surface 631a, second hole flat wall surface 632a, first hole circumferential wall surface 633a, and second hole circumferential wall surface 634a. First hole flat wall surface 631a is disposed to face first straight portion 131 with a clearance therebetween. Second hole flat wall surface 632a is disposed to face second straight portion 132 with a clearance therebetween. First hole circumferential wall surface 633a is disposed to face first circumference portion 133 with a clearance therebetween. Second hole circumferential wall surface 634a is disposed to face second circumference portion 134 with a clearance therebetween.

Transmission suppression section 80 includes first contact portions 81 that are disposed on first hole flat wall surface 631a and that partially come into contact with first straight portion 131. First contact portions 81 have functions such as absorption of the click vibration, transmission performance of transmitting the rotational force from first straight portion 131 to rotary body 60, and reduction of a frictional resistance against first straight portion 131 during the axial operation. Based on these functions, a disposition position, a size, a shape, and the like of first contact portions 81 are set.

First contact portions 81 come into contact respectively with portions of first straight portion 131 that are spaced from each other in the direction about the axis. Each of first contact portions 81 includes a bead portion that extends along the axial direction (X direction). The bead portion has a mountain-type cross-sectional shape in which a top side is directed to the first straight portion 131 side and a bottom side is directed to the first hole flat wall surface 631a side. In other words, first contact portions 81 include two bead portions in which the same cross-sectional shapes provided to continue in the X direction. The number of bead portions (the number of bead portions disposed in the X direction and the number of bead portions disposed in a direction parallel to the Y direction), the length of each bead portion in the X direction, and the cross-sectional shape of the bead portion are not limited thereto.

Transmission suppression section 80 includes second contact portions 82 that are disposed on second hole flat wall surface 632a and that partially come into contact with second straight portion 132. Second contact portions 82 come into contact respectively with portions of second straight portion 132 that are spaced from each other in the direction about the axis. Each of second contact portions 82 has functions such as absorption of the click vibration, transmission performance of transmitting the rotational force from second straight portion 132 to rotary body 60, and reduction of a frictional resistance against second straight portion 132 during the axial operation. Based on these functions, a disposition position, a size, a shape, and the like of second contact portions 82 are set. Second contact portion 82 is the same as first contact portion 81 except that the disposition thereof is symmetrically disposed with respect to the axis with first contact portion 81, and thus the description thereof will be omitted.

Rotary electronic component 1 according to Variation 1 further includes transmission suppression section 80 that is disposed in rotary body 60 and that can suppress the transmission of the click vibration to rotary body 60 via operation shaft 10. Since the click vibration transmitted from click mechanism 70 to rotary body 60 via operation shaft 10 is reduced by transmission suppression section 80, rotary body 60 can output a stable electric signal during the rotational operation.

In addition, in rotary electronic component 1 according to Variation 1, first hole flat wall surface 631a that is a hole wall surface of through-hole 63a partially comes into contact with first straight portion 131 of small-diameter portion 13 (operation shaft 10) in transmission suppression section 80. In addition, second hole flat wall surface 632a that is a hole wall surface of through-hole 63a partially comes into contact with second straight portion 132. Accordingly, a partial contact portion that partially comes into contact with first straight portion 131 of first hole flat wall surface 631a is easily deformed, and a partial contact portion that partially comes into contact with second straight portion 132 of second hole flat wall surface 632a is easily deformed. The easier the partial contact portions are deformed, a performance of absorbing the click vibration by the partial contact portions is improved, and thus the click vibration transmitted from click mechanism 70 to rotary body 60 via operation shaft 10 can be further reduced. In addition, since the frictional resistance of first hole flat wall surface 631a against first straight portion 131 during the axial operation is reduced and the frictional resistance of second hole flat wall surface 632a against second straight portion 132 is reduced, it is possible to suppress a decrease in axial operability.

In addition, in rotary electronic component 1 according to Variation 1, the axial wall surface of small-diameter portion 13 (operation shaft 10) has a racetrack-shaped cross-sectional shape, and includes first straight portion 131 and second straight portion 132 that are disposed to face each other with a center (axial center) of the racetrack-shaped cross-sectional shape of the racetrack shape interposed therebetween, and transmission suppression section 80 includes first contact portions 81 that come into contact with parts of first straight portion 131 and second contact portions 82 that come into contact with parts of second straight portion 132. Accordingly, a portion where the wall surface of through-hole 63a comes into contact with the axial wall surface of small-diameter portion 13 is minimized. In other words, the portion where the wall surface of through-hole 63a comes into contact with the axial wall surface of small-diameter portion 13 is significantly reduced. Therefore, the click vibration transmitted from click mechanism 70 to rotary body 60 via operation shaft 10 can be further reduced. In addition, it is possible to further suppress a decrease in axial operability.

In rotary electronic component 1 according to Variation 1, first contact portions 81 come into contact respectively with the portions of first straight portion 131 that are spaced from each other in the direction about the axis, and second contact portions 82 come into contact respectively with the portions of second straight portion 132 that are spaced from each other in the direction about the axis. Accordingly, during the clockwise rotational operation, one portion of first contact portions 81 that are spaced from each other comes into contact with first straight portion 131, and one portion of second contact portions 82 that are spaced from each other comes into contact with second straight portion 132. During the counterclockwise rotational operation, the other portion of first contact portion 81 that are spaced from each other comes into contact with first straight portion 131, and the other portion of second contact portions 82 that are spaced from each other comes into contact with second straight portion 132. Accordingly, it is possible to suppress a decrease in rotational operability. In addition, the number of contact portions can be reduced. Accordingly, the frictional resistance of the contact portion against first straight portion 131 and the frictional resistance of the contact portion against second straight portion 132 are reduced, and thus it is possible to further suppress a decrease in axial operability.

In rotary electronic component 1 according to Variation 1, first contact portions 81 and second contact portions 82 include the bead portions that extend along the axial direction. Accordingly, the shape of the bead portion and the number of bead portions can be set based on the absorption of the click vibration, the rotational operability, and the axial operability.

In Variation 1, transmission suppression section 80 is disposed in rotary body 60, but the present invention is not limited thereto. Transmission suppression section 80 may be disposed in at least one of operation shaft 10 or rotary body 60. For example, two bead portions (contact portions) that are spaced from each other in the direction about the axis may be disposed on the axial wall surface of small-diameter portion 13 (operation shaft 10). In this case, the bead portion can come into contact with the hole circumferential wall surface of through-hole 63 of rotary body 60. The hole circumferential wall surface is elastically deformed by the bead portion, and thus the click vibration transmitted from click mechanism 70 to rotary body 60 via small-diameter portion 13 is absorbed.

Next, Variation 2 of rotary electronic component 1 according to the embodiment of the present invention will be described. The axial wall surface of small-diameter portion 13 according to the embodiment and Variation 1 has a constant racetrack-shaped cross-sectional shape at each position in the axial direction (X direction). For example, small-diameter portion 13 also has the constant racetrack-shaped cross-sectional shape in a region between a position where rotary body 60 is supported and a position where click mechanism 70 is supported.

On the other hand, in the axial wall surface of small-diameter portion 13 according to Variation 2, a circumferential groove having a predetermined groove depth and extending in the direction about the axis is disposed in the region between the position where rotary body 60 is supported and the position where click mechanism 70 is supported.

In Variation 2, since the circumferential groove is disposed in the region, the click vibration transmitted from click mechanism 70 to rotary body 60 via the axial wall surface (surface) of small-diameter portion 13 can be further reduced.

The rotary electronic component according to the present invention may be configured by combining rotary electronic component 1 according to Variation 2 with rotary electronic component 1 according to the embodiment or rotary electronic component 1 according to Variation 1.

The above-described embodiments are merely specific examples of the present invention, and the technical scope of the present invention is not to be construed in a limited manner by the above-described embodiments. That is, the present invention can be implemented in various forms without departing from the spirit or the main features thereof.

### Industrial Applicability

The present invention is suitably used in an electronic apparatus including a rotary electronic component in which it is required to suppress transmission of a click vibration to a rotary body.

1. A rotary electronic component, comprising:
a main body;
an operation shaft supported by the main body to be rotatable about an axis extending in one direction;
a click mechanism supported by the operation shaft and capable of generating a click vibration in response to rotation of the operation shaft; and
a rotary body disposed on the operation shaft at a position away from the click mechanism in the one direction, the rotary body being supported to be integrally rotatable with the operation shaft, the rotary body being capable of generating an electric signal in response to the rotation of the operation shaft.

2. The rotary electronic component according to claim 1, further comprising:
a transmission suppression section disposed in at least one of the operation shaft and the rotary body and capable of suppressing transmission of the click vibration to the rotary body via the operation shaft.

3. The rotary electronic component according to claim 2, wherein:
the rotary body includes a through-hole through which the operation shaft penetrates, and
the transmission suppression section includes a contact portion such that at least one wall surface of an axial wall surface of the operation shaft and a hole wall surface of the through-hole partially comes into contact with the other of the axial wall surface of the operation shaft and the hole wall surface of the through-hole.

4. The rotary electronic component according to claim 3, wherein:
the at least one wall surface of the axial wall surface of the operation shaft and the hole wall surface of the through-hole has a racetrack-shaped cross-sectional shape, and includes a first straight portion and a second straight portion that are disposed to face each other with a center of the racetrack-shaped cross-sectional shape interposed therebetween, and
the transmission suppression section includes a first contact portion that comes into contact with a part of the first straight portion and a second contact portion that comes into contact with a part of the second straight portion.

5. The rotary electronic component according to claim 4, wherein:
the first contact portion comes into contact with each of parts of the first straight portion that are spaced from each other in a direction about the axis, and
the second contact portion comes into contact with each of parts of the second straight portion that are spaced from each other in the direction about the axis.

6. The rotary electronic component according to claim 5, wherein
the first contact portion and the second contact portion include a bead portion that extends along the one direction.

7. The rotary electronic component according to claim 6, wherein
a circumferential groove having a predetermined groove depth and extending in the direction about the axis is disposed in the operation shaft in a region between a position where the rotary body is supported and a position where the click mechanism is supported.

8. The rotary electronic component according to claim 1, further comprising:
a resistor disposed in the main body; and
a movable contact disposed on the rotary body and movable on the resistor in response to the rotation of the operation shaft about the axis.
